(19) United States
(12) Patent Application Publication
(10) Pub. No.: US 2005/0124311 A1
(43) Pub. Date: Jun. 9, 2005

(54) Low-voltage low-power high-linearity active CMOS mixer

(76) Inventors: Farsheed Mahmoudi, Toronto (CA); C. Andre T. Salama, Toronto (CA)

Correspondence Address: MARKS & CLERK, P.O. BOX 957, STATION B, OTTAWA, ON, K1P 5S7, CA

(21) Appl. No.: 10/725,513

(22) Filed: Dec. 3, 2003

(51) Int. Cl. H04B 1/26

(52) U.S. Cl. 455/323

(57) ABSTRACT

A low voltage, low power, high linearity active CMOS mixer for radio frequency (RF) wireless communication applications consists of high linearity RF transconductor to convert the incoming RF voltage into a RF current; an ac-coupling stage to deliver the RF current to the next stage, and to block the DC signal and the flicker noise of the RF transconductor; followed by a current commutating (mixing) stage to down-convert the RF signal to the desired intermediate frequency (IF), and an IF section that converts the down-converted signal current back to voltage. The invention suggests a novel low-voltage, low-power RF mixer circuit that exhibits a high linearity in terms of IIP2 and IIP3 and is suitable for a low voltage, direct conversion receiver (DCR) which requires a relatively high IIP2. The DCR is a candidate for the fourth generation of mobile communication systems (4G).

### FIELD OF THE INVENTION

This invention relates to RF mixers and more particularly to high linearity, low voltage, and low power mixers for applications such as mobile communications.

### BACKGROUND

With the ever increasing demand for high bandwidth communication systems such as current mobile systems and more particularly next generation mobile communications services comes the need for systems and methods for efficiently meeting these increased demands while maintaining low voltage operations. The fourth generation (4G) mobile systems, for example, will require support for interactive multi-media services including teleconferencing, wireless Internet etc. To meet these demands current and future systems will need to support much higher bit rates while maintaining low costs.

As bit rates increase the requirement for linearity, within the receiver's signal processing components in particular, becomes more important. In most current RF receivers the incoming RF signal is captured by the antenna and is then translated to intermediate frequencies (IF) for further signal processing by the analogue or digital sections of the receiver. This frequency translation of the received signal is typically carried out by a mixer.

In order to satisfy future needs the linearity of the mixer will play a crucial role in the overall performance of the RF receiver due to the relative high data rates associated with future mobile communication systems. Therefore, a high linearity mixer which preserves the simplicity of the design and other figures of merit at reasonable levels and fits in a low voltage scheme is not only desirable but needed to satisfy the requirements of the next generation of digital communication systems.

FIG. 1 illustrates the most popular and simplest active mixer architecture employed in current RF receivers. It is based on the Gilbert type active mixer and operates on a well known current commutation principle. As illustrated in FIG. 1, in a typical current commutating mixer, the input voltage is first transformed into a current followed by a mixing stage that commutates its input current between the two differential paths at the local oscillator frequency and hence translates the information bearing signal to the desired intermediate frequency (IF). The resulting down-converted signal is then transformed back to voltage in the IF stage which typically consists of a simple differential load.

A typical current commutating mixer, despite its wide spread use, has a disadvantage in that it demonstrates a strong coupling between power gain, linearity and the noise figure. This means that a reasonably high linearity, as will be called for by future mobile applications, typically results in poor power gain and noise figure.

Two U.S. patents, namely U.S. Pat. No. 6,094,084 which issued Jul. 25, 2000 to Abou-Allam et al. and U.S. Pat. No. 6,232,848 which issued May 15, 2001 to Manku are examples of prior art attempts to accommodate a current commutating mixer in a low voltage design. Although these patents relate to low voltage implementations they do not purport to provide enhancement of the linearity performance for the active mixer. In addition to the aforementioned patents publications such as “High Linearity RF CMOS Amplifier and Mixer Adapting MOSFET Transconductance Linearization by Multiple Gated Transistors” by Kim et al. (IEEE Rdio Frequency Integrated Circuits Symposium, Proceedings, pp 107-110, 2003) do not attempt to address the aforementioned coupling between power gain, noise figure and linearity.

An earlier paper entitled “A Voltage-Controllable Linear MOS Transconductor Using Bias Offset Technique” by Wang et al. (IEEE Journal of Solid-State Circuits, Vol. 25, pp. 315-317, 1990) represents an attempt at achieving high linearity CMOS transconductors.

Among the various blocks participating in the architecture of a typical current commutating mixer, the transconductor is the most responsible element for the poor linearity of this type of mixer. Due to this characteristic even the most recent design attempts do not significantly improve the inherent noise-linearity trade-off in the RF mixer. Therefore, a simultaneous achievement of reasonable power gain and adequate linearity while maintaining the circuit simplicity is highly desirable. Previous state of the art designs either add to the complexity of the design or include unreasonable amounts of inductive degeneration.

Accordingly, there is a need for a low-voltage, low-power high-linearity active CMOS mixer for RF wireless communications applications.

### SUMMARY OF THE INVENTION

The present invention seeks to provide a low-voltage, low-power, high linearity active CMOS mixer for radio frequency wireless communication applications incorporating an improved RF transconductor.

To this end, the present invention provides the aforementioned mixer having a high-linearity RF transconductor to convert the incoming RF voltage into an RF current; an AC-coupling stage to deliver the RF current to a next stage and to block the DC signal and the flicker noise of the RF transconductor; the AC coupling stage is connected to a current commutating mixing stage to down convert the RF signal to the desired intermediate frequency (IF) and an IF section that converts the down converted signal current back to an RF voltage.

In accordance with a second aspect of the invention there is provided an RF transconductance amplifier for use in a high linearity, low power, low voltage active mixer, the RF transconductance amplifier comprising; a floating voltage source; a capacitive feed-forward path; and a p-channel and an n-channel single transistor transconductors.

In accordance with a third aspect of the invention there is provided a method of improving the linearity of a current commutating active mixer comprising: transforming the input voltage to a current through a transconductance amplifier, the transconductance amplifier having transconductors which compensate each other's nonlinearities resulting in a constant transconductance over a wide range of input differential voltages; down-converting the RF current to the desired IF with a mixing stage; ac-coupling the RF transconductance amplifier and the mixing stage; and converting an information bearing signal back to voltage using an IF stage.

In a preferred embodiment of the invention an improved transconducting amplifier is provided.

### BRIEF DESCRIPTION OF THE DRAWINGS

The invention will now be described in greater detail with reference to the attached drawings wherein:

FIG. 1 is a prior art current commutating mixer architecture;

FIG. 2 shows one mixer according to the prior art;

FIG. 3 shows a second prior art mixer;

FIG. 4 illustrates a circuit drawing of a low-voltage low-power high-linear active CMOS mixer according to the present invention; and

FIG. 5 is a micrograph of the mixer of FIG. 4.

### DETAILED DESCRIPTION OF THE INVENTION

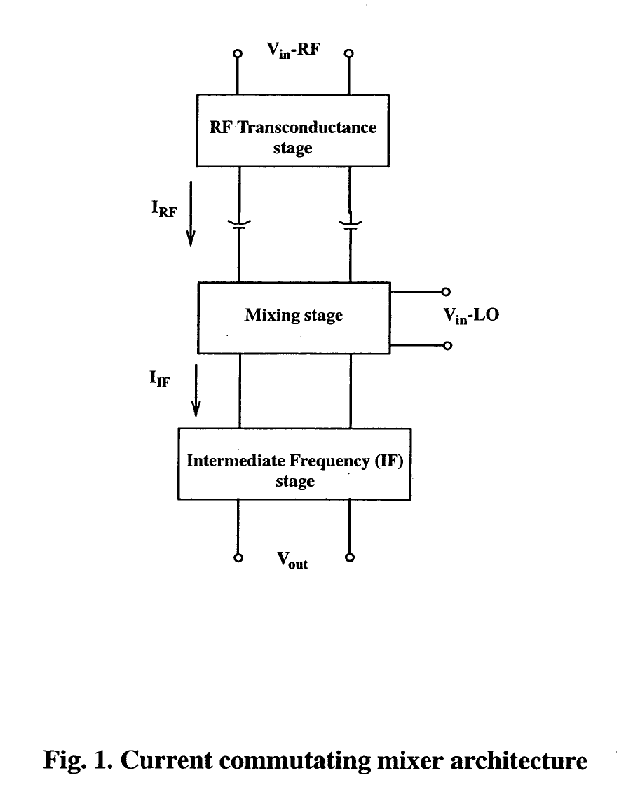

As indicated previously the basic concept of a current commutating mixer is shown in FIG. 1. The RF signal is fed to the RF transconductance stage and then to the mixing stage where it is mixed with the local oscillator signal to generate an intermediate frequency current signal which is converted to an RF voltage out at the IF stage.

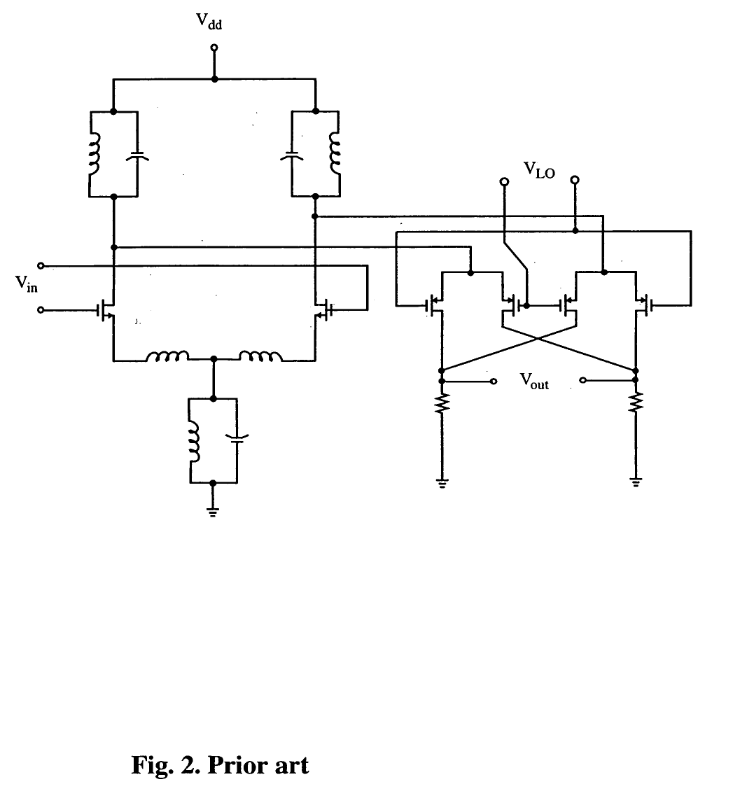

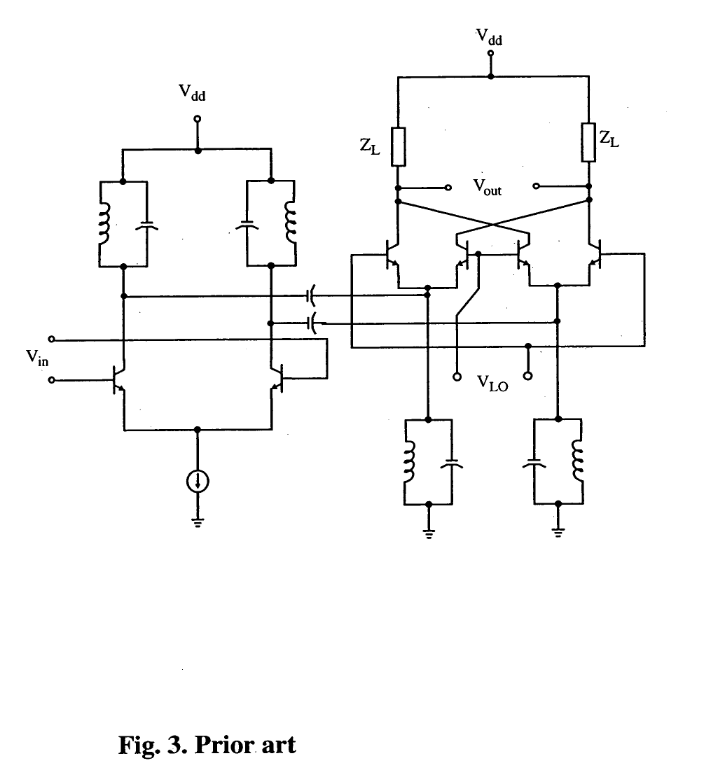

FIGS. 2 and 3 illustrate prior art attempts to generate low voltage mixers without any particular attention paid to achieving high linearity.

As discussed previously, the RF transconductor typically contributes signficantly to the non-linearity of a mixer circuit.

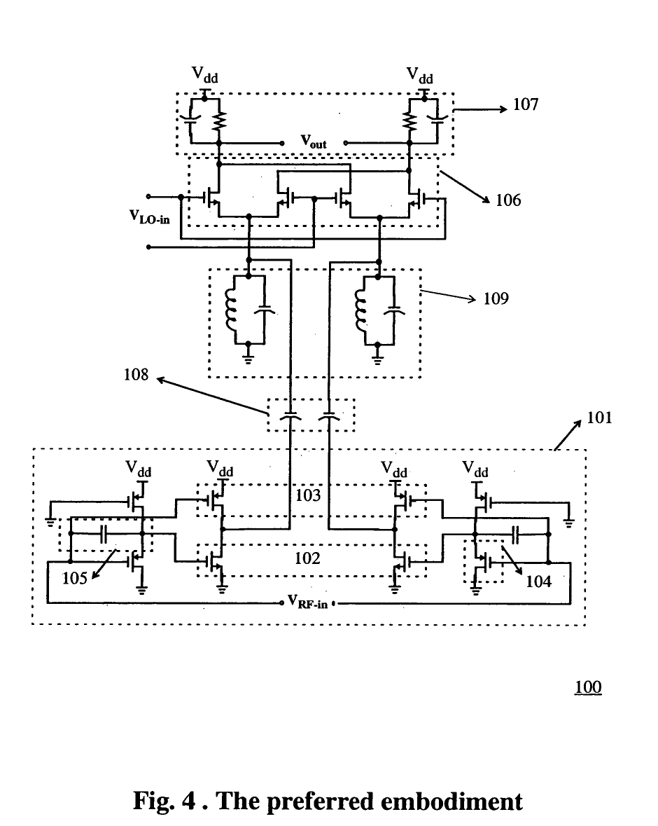

The mixer according to the present invention is shown generally at 100 in FIG. 4. As shown the high-linearity, low-voltage, low-power active mixer consists of an RF transconductance amplifier shown generally at 101. The novel design of RF transconductor amplifier 101 makes a significant contribution to the overall novelty of the mixer according to the present invention. This contribution is achieved by establishing improved linearity of the transconductor stage.

As shown in FIG. 4 the RF voltage signal from the antenna is coupled to n-channel 102 and p-channel 103 transconductors. Additionally, the input signal is coupled to the gate of floating voltage source 104 and through capacitor 105 to the gate of n-channel transconductor 102. By properly offsetting the bias of the n-channel 102 and p-channel 103 tranconductors a constant transconductance is obtained over a relatively wide range of input differential voltages resulting in improved linearity.

The floating voltage source 104 is introduced in the design to provide the required constant transconductance by offsetting the bias of the two transconductor transistors by the required amount. The capcitor 105 introduced in the design provides a feed forward path for the RF signal and improves the high frequency performance of the floating voltage source.

In order to further improve the linearity of the transconductance stage the threshold-voltage-modulation assisted non-linearity is eliminated by shorting the source-bulk junctions of all the transistors involved in the RF transconductor stage 101. Further, the RF transconductor stage 101 is self biased and does not require any additional biasing circuitry.

The RF current signal from the transconductor stage 101 is coupled to mixer stage 106 through the AC coupling stage 108. The AC coupling prevents the flicker noise associated with the RF transconductor from reaching the output in addition to providing independent biasing and optimization for the RF and local oscillator stages. The output of the AC coupling is supplied to the cross coupled mixer stage 106 which is also provided with the local oscillator input signal. Mixer 106 produces the IF output which is fed to the IF stage 107, IF stage 107 being a low pass load. The IF voltage out is provided by the IF stage as is known in the prior art. The low pass load 107 filters out the undesired frequency content of the output signal. The tail current source of the mixing stage is replaced by a tuned tail 109 which allows the low voltage operation and further filtering of RF signal and the accompanying noise.

The novel low-voltage, low-power RF mixer circuit according to the present invention exhibits a high linearity in terms of both IIP2 and IIP3 and therefore fits into a low voltage direct conversion receiver (DCR) which requires a relatively high IIP2.

The applicants believe that the technique according to the present invention has never been applied to RF mixers before. Due to the excellent IIP2 and IIP3 high gain and good noise figures the mixers is well suited for application in a direct conversion receiver which is a candidate for implementation of RF receivers in the next generation of mobile communication systems.

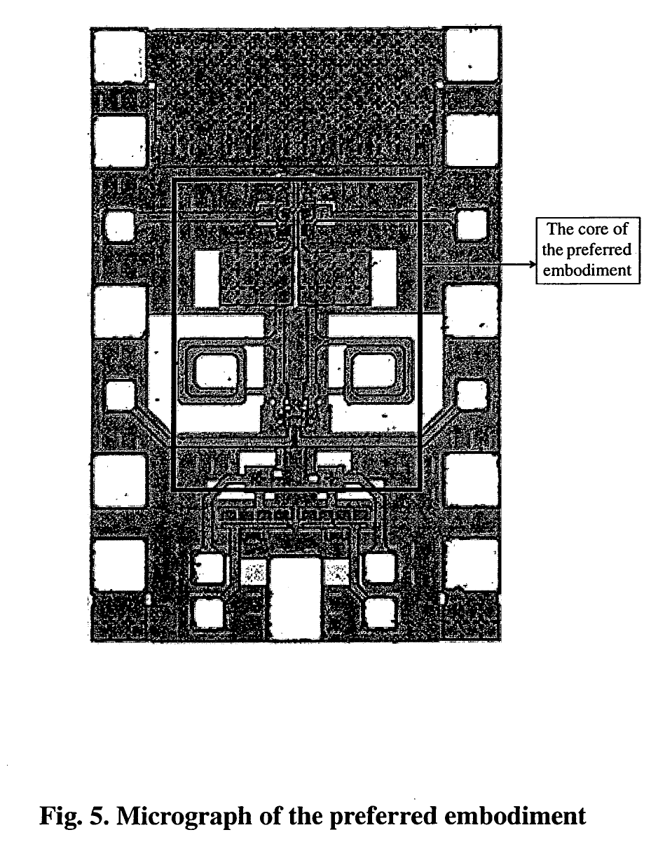

The circuit according to the present invention is implemented by employing a CMOS 0.18 micron technology and a micrograph of the chip is shown in FIG. 5.

Experimental results obtained from the device of FIG. 5 are tabulated in Table 1 below.

TABLE 1
Experimental results of the preferred embodiment

| | this Work | |
|---|---|---|
| Power conversion gain | +6.5 | dB |
| 1-dB Compression point | −5.5 | dBm |
| IIP3 | +3.5 | dBm |
| IIP2 | >+48 | dBm |
| Power dissipation | 6.9 | mW |
| LO power | −3 | dBm |
| RE frequency | 8 | GHz |
| LO frequency | 8 | GHz |
| Supply voltage | 1 | V |
| Noise figure (SSB) | 11 | dB |
| LO-RF Isolation | 60 | dB |
| CMOS Technology | 0.18 | μm |
| Area | 0.32 × 0.4 | mm² |

Although specific embodiments of the invention have been illustrated and described it will be apparent to one skilled in the art that numerous changes can be made without departing from the basic concept. It is to be understood, however, that such changes will fall within the full scope of the invention as defined by the appended claims.

1. A high linearity, low power, low voltage active mixer for RF applications, comprising:
an RF transconductance amplifier to transform the input voltage to current, the transconductance amplifier having a constant transconductance over a wide range of input differential voltages;
a mixing stage to down-convert the RF current to the desired IF;
an ac-coupling stage between the RF transconductance amplifier and the mixing stage; and
an IF stage that converts an information bearing signal back to voltage.

2. A high linearity, low power, low voltage active mixer as in claim 1, wherein the transconductors with constant transconductance result in high linearity in terms of both IIP2 and IIP3.

3. A high linearity, low power, low voltage active mixer as in claim 2, wherein the RF transconductance amplifier consists of:
a floating voltage source;
a capacitive feed-forward path; and
a p-channel and an n-channel single transistor transconductors.

4. A high linearity, low power, low voltage active mixer comprising a transconductor as in claim 3, wherein the body-effect of the transistor transconductance is eliminated to improve the linearity by obviating the threshold-voltage-modulation assisted nonlinearity.

5. A high linearity, low power, low voltage active mixer as in claim 3 comprising a floating voltage source in the RF transconductance amplifier that allows the low voltage operation of the RF transconductor stage.

6. A high linearity, low power, low voltage active mixer as in claim 3, wherein the RF transconductance stage is self-biased and does not require any additional biasing circuitry.

7. A high linearity, low power, low voltage active mixer as in claim 3, wherein the concept of current reuse has been introduced to decrease the power consumption of the design.

8. A high linearity, low power, low voltage active mixer as in claim 1, wherein the ac-coupling between the RF transconductor and the mixing stage blocks the flicker noise associated with the RF transconductor, and hence reduces the total flicker noise at the output, which favors the design for direct conversion applications.

9. A high linearity, low power, low voltage active mixer as in claim 1, wherein the mixing stage is connected to ground through a tuned load, that allows for the low voltage operation of a local oscillator stage.

10. A high linearity, low power, low voltage active mixer as in claim 9, that provides further filtering of the incoming RF signal and the accompanied noise due to the presence of the tuned load in the mixing stage.

11. A high linearity, low power, low voltage active mixer as in claim 1, which shows excellent linearity (IIP2, IIP3) and therefore fits in a direct conversion receiver.

12. An RF transconductance amplifier for use in a high linearity, low power, low voltage active mixer, the RF transconductance amplifier comprising;
a floating voltage source;
a capacitive feed-forward path; and
a p-channel and an n-channel single transistor transconductors.

13. An RF transconductance amplifier as defined in claim 12 wherein the body-effect of the transistor transconductance is eliminated to improve the linearity by obviating the threshold-voltage-modulation assisted nonlinearity.

14. An RF transconductance amplifier as defined in claim 12 wherein the RF transconductance stage is self-biased and does not require any additional biasing circuitry.

15. An RF transconductance amplifier, as defined in claim 12, wherein a floating voltage source causes the transconductor transistors to operate simultaneously in the active region over a wide range of input differential voltages thus resulting in improved linearity in terms of IIP2.

16. A method of improving the linearity of a current commutating active mixer comprising:
transforming the input voltage to current with a transconductance amplifier, the transconductance amplifier having transconductors with constant transconductance over a wide range of differential input voltages;
down-converting the RF current to the desired IF with a mixing stage;
ac-coupling the RF transconductance amplifier and the mixing stage; and
converting an information bearing signal back to voltage using an IF stage.
